(19) United States
(12) Patent Application Publication
(10) Pub. No.: US 2005/0019094 A1
(43) Pub. Date: Jan. 27, 2005

(54) Simplifiles

(76) Inventors: William T. Hayes II, DePere, WI (US); Ronald N. Demske, Greenleaf, WI (US); Michael Schaefer, Celebration, FL (US); Steven Bair, Winter Garden, FL (US)

Correspondence Address: William T. Hayes II;c/o HC Miller Company, 3030 Lowell Drive, Green Bay, WI, 54311, US

(21) Appl. No.: 10/750,494

(22) Filed: Jul. 15, 2004

Related U.S. Application Data
(60) Provisional application No. 60/464,564, filed on Apr. 22, 2003.

(51) Int. Cl. B42F 13/00

(52) U.S. Cl. 402/73

(57) ABSTRACT

The ‘Simple-File’ is a new product for the filing system industry and was designed to assist the medical community in replacing large, bulky folders. The product incorporates a file folder and internal index tab dividers, preassembled with a double loop wire (wire-o) binding. The ‘Simple-File’ system allows the index tab dividers to easily turn, lie flat and open flat, functioning much like a book. The internal tab dividers are furnished with side or bottom tabs, printed on one or two sides. Each divider includes metal fasteners, heat-bonded to the front and/or back of the divider for easy insertion or removal of material. The number of dividers required per assembly can be customized to fit the filing system requirements.

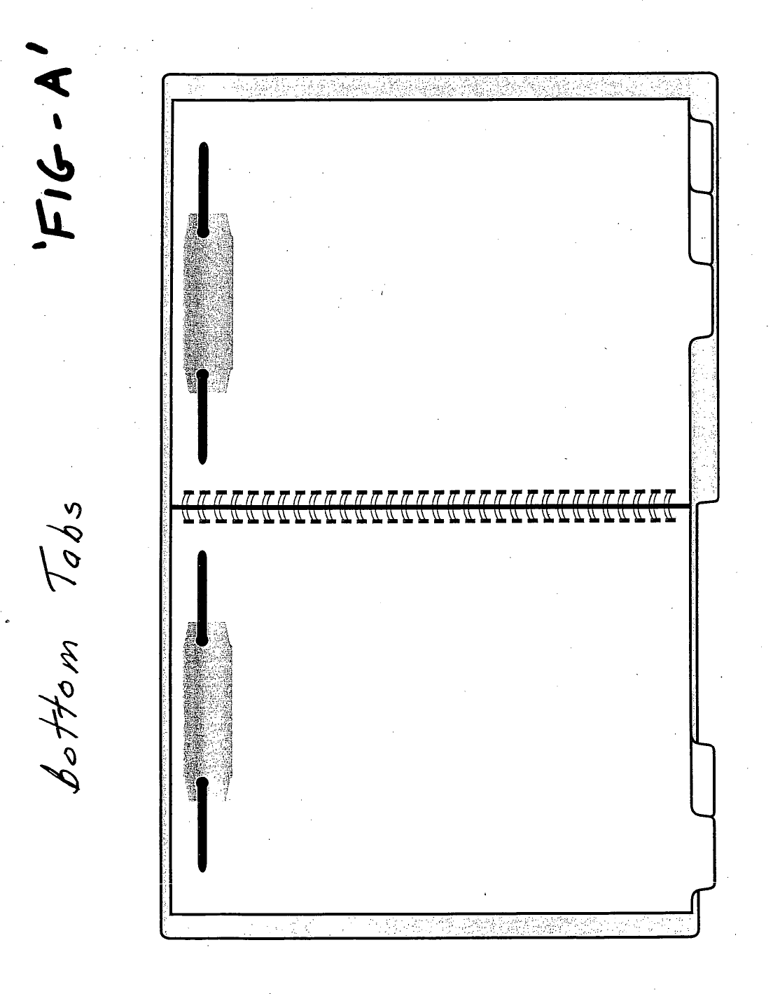

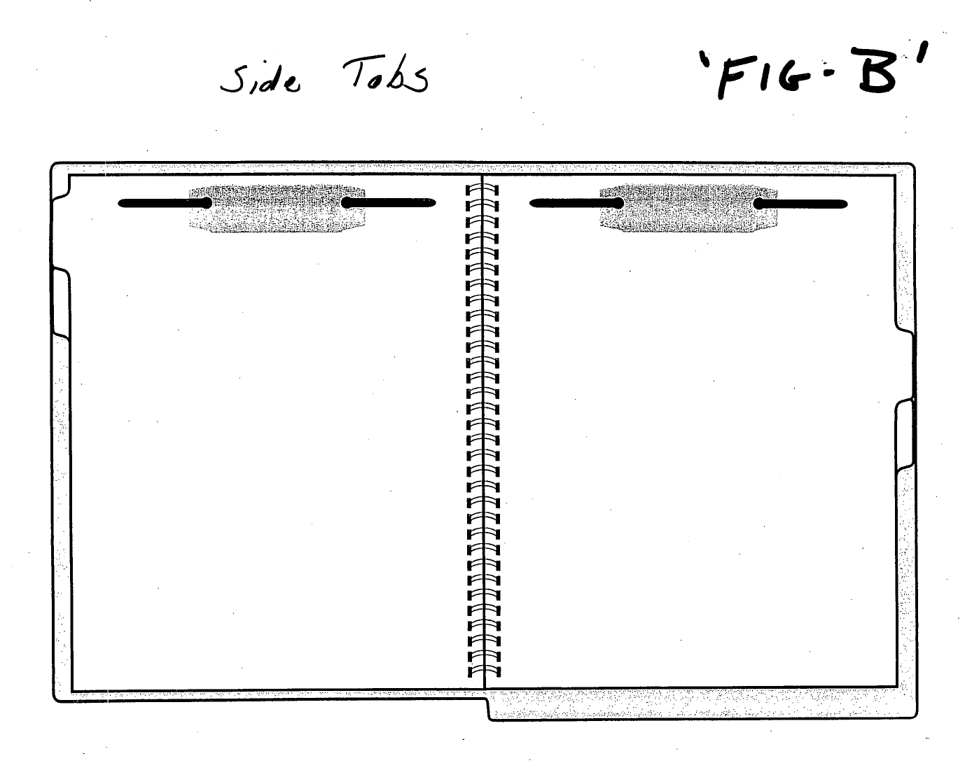

The ‘Simplifiles’ is a new product for the filing system industry and was designed to assist the medical community in replacing large, bulky file folders.

The product incorporates a file folder and internal index tab dividers, preassembled with a double loop wire (Wire-O) binding. The ‘Simplifiles’ system allows the index tab dividers to easily turn, lie flat and open flat, functioning much like a book.

The internal tab dividers are furnished with side or bottom tabs, printed on one or two sides. Each divider includes metal fasteners, heat-bonded to the front and/or back of the divider for easy insertion or removal of material. The number of dividers required per assembly can be customized to fit the filing system requirements.

### SUMMARY OF INVENTION

Unique filing system used in combination with existing filing systems assembled into a product that uses a file folder, spiral binding and tab cutting techniques in a unique all-in-one inclusive filing system. It is an easy to use single source location for all correspondence that needs to be attached and stored in a single file.

### BRIEF DESCRIPTION OF DRAWINGS

FIG. A—Bottom Tabs

In this diagram we display standard tab positions located at bottom of filing system showing position of tabs, fasteners and location of the outside cover filing folder. Note: Once system is closed all pertinent document information and tab titles are subsequently covered, insuring privacy. Unique extension location at bottom of file folder allows for the system to be filed by color code or alpha numerically for easy use.

FIG. B—Side Tabs

In this diagram we display standard tab position located at side of filing system showing position of tabs, fasteners and location of the outside cover filing folder. Note: Once system is closed all pertinent document information and tab titles are subsequently covered insuring privacy. Unique extension location at bottom of file folder allows for the system to be filed by color code or alpha numerically for easy use.

Prototype A—Bottom Simple-File

Prototype A shows complete system with double wire-o binding, four subsequent tabs with fastener adhered to the front and back of each tab page. Unique tab extension location at bottom of file folder allows for the system to be filed by color code or alpha numerically for easy use.

Prototype B—Side Simple-File

Prototype B shows complete system with double wire-o binding, four subsequent tabs with fastener adhered to the front and back of each tab page. Unique tab extension location at bottom of file folder allows for the system to be filed by color code or alpha numerically for easy use.

1. The system provides a combination of pre-existing components that supports multiple correspondence to be attached to a filing system. It is used in the medical and/or financial industry for additional privacy and convenience.
The unique combination of single standing individual tabs with a permanent fastener used on both front and/or back of the tab, bound in such a way that it is in a booklet format in combination with four subsequent tabs with specific titles for each industry, allows for easy organization and filing of pertinent and personal health information or financial information so that research is quick, simple and easy:
The unique file folders with hidden spiral binding allows for all inside documents to remain covered so that no information is exposed to the public until the file is opened. The unique extension location at bottom of file folder allows for the system to be filed by color code or alpha numerically for easy use. Prior systems would not allow for all of the tabs and documents to be adhered in the system without individual assembly and insertion into a standard file folder with no method of holding them together.
